(19) United States
(12) Patent Application Publication
(10) Pub. No.: US 2011/0273795 A1
(43) Pub. Date: Nov. 10, 2011

(54) LIBRARY APPARATUS AND LIBRARY APPARATUS CONTROLLING METHOD

(75) Inventor: Keisuke HOSHINO, Kawasaki (JP)

(73) Assignee: FUJITSU LIMITED, Kawasaki (JP)

(21) Appl. No.: 13/186,975

(22) Filed: Jul. 20, 2011

Related U.S. Application Data
(63) Continuation of application No. PCT/JP2009/000521, filed on Feb. 10, 2009.

(51) Int. Cl. G11B 15/68

(52) U.S. Cl. 360/92.1; G9B/15.135

(57) ABSTRACT

A library apparatus for conveying, with a conveying device, a cartridge storing data between a cartridge storing unit and a drive accessing the data stored in the cartridge, the library apparatus includes: a target position deciding unit configured to decide a target position, to which the conveying device is to be moved, based on a position of a gravity point of the library apparatus, and stable position information that is predetermined position information of the gravity point at which the library apparatus becomes stable; and a controlling unit configured to control and drive the conveying device to move to the target position when a vibration applied to the library device is detected.

### CROSS-REFERENCE TO RELATED APPLICATION

This application is a continuation of PCT application PCT/JP 2009/000521 filed on Feb. 10, 2009.

### FIELD

The embodiments discussed herein are related to a library apparatus, and a library apparatus controlling method.

### BACKGROUND

Conventionally, structures of magnetic tape library apparatuses have been reviewed to increase storage capacities against footprints of the apparatuses, and the number of accommodated magnetic tape cartridges has been increased. As a result, the footprints of the magnetic library apparatuses were reduced to, for example, a little under 2 m², leading to space saving.

In the meantime, a storage device of a magnetic tape cartridge having a cell block configured by arranging a plurality of layered cells so that a cartridge slot faces in a running direction of an accessor, a stocker frame that holds the cell block in a direction perpendicular to the running direction of the accessor, and moving means for moving the cell block is proposed.

However, if the footprints of the magnetic tape library apparatuses decrease, this causes a disadvantage that the apparatuses more tend to be toppled down by an external vibration such as an earthquake or the like. Moreover, if the number of accommodated magnetic tape cartridges increases within a magnetic tape library apparatus, for example, the height of the apparatus grows, so that the apparatus more tends to topple down.

Measures of attaching a stabilizer to a library apparatus is considered as measures taken to prevent the library apparatus typified by the above described magnetic tape library apparatus or the like from toppling down. With this measures, however, the footprint of the entire apparatus is increased by the stabilizer, prohibiting the space from being saved.
[Patent Document 1] Japanese Laid-open Patent Publication No. HEI2-35652

### SUMMARY

According to an aspect of the invention, a library apparatus for conveying, with a conveying device, a cartridge storing data between a cartridge storing unit and a drive accessing the data stored in the cartridge, the library apparatus includes: a target position deciding unit configured to decide a target position, to which the conveying device is to be moved, based on a position of a gravity point of the library apparatus, and stable position information that is predetermined position information of the gravity point at which the library apparatus becomes stable; and a controlling unit configured to control and drive the conveying device to move to the target position when a vibration applied to the library device is detected.

According to an another aspect of the invention, a controlling method for a library apparatus for conveying, with a conveying device, a cartridge storing data between a cartridge storing unit and a drive accessing the data stored in the cartridge, the controlling method includes: deciding a target position, to which the conveying device is to be moved, based on a position of a gravity point of the library apparatus, and stable position information that is predetermined position information of the gravity point at which the library apparatus becomes stable; and controlling and driving the conveying device to move to the target position when a vibration applied to the library apparatus is detected.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 illustrates a configuration example of a library apparatus according to an embodiment;

FIG. 2 illustrates an example of a top view of a magnetic tape library apparatus according to the embodiment;

FIG. 3 illustrates an example of a side view of the magnetic tape library apparatus according to the embodiment;

FIG. 4 illustrates a configuration example of a controller included in the magnetic tape library apparatus according to the embodiment;

FIG. 5 illustrates an example of configuration information of the magnetic tape library apparatus within a configuration information DB;

FIG. 6 illustrates an example of an intensity scale decision table;

FIG. 7 illustrates an example of an aftershock termination prediction time calculation table;

FIG. 8 illustrates an example of a control process flow of the magnetic tape library apparatus in the embodiment;

FIG. 9 illustrates the example of the control process flow of the magnetic tape library apparatus in the embodiment;

FIG. 10 illustrates an example of a control process flow of the magnetic tape library apparatus in another embodiment;

FIG. 11 illustrates the example of the control process flow of the magnetic tape library apparatus in the another embodiment;

FIG. 12 illustrates the example of the control process flow of the magnetic tape library apparatus in the another embodiment; and

FIG. 13 illustrates the example of the control process flow of the magnetic tape library apparatus in the another embodiment.

### DESCRIPTION OF EMBODIMENTS

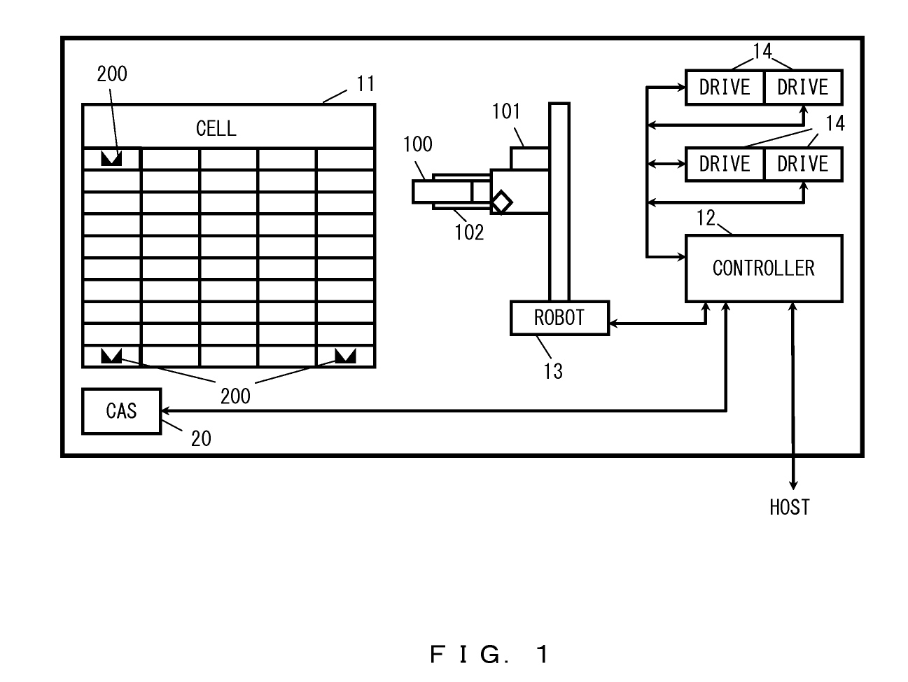

FIG. 1 illustrates a configuration example of a library apparatus according to an embodiment. FIG. 1 is described by taking, as an example, a magnetic tape library apparatus as the library apparatus according to the embodiment. In the magnetic tape library apparatus illustrated in FIG. 1, for example, several tens to several hundreds of magnetic tape cartridges 100 storing data are retained in a storage rack (cartridge storing unit) called a cell 11. When a data read/write request is issued from a host computer (hereinafter referred to as a host), a controller 12 included in the magnetic tape library apparatus drives and controls a robot 13. The robot 13 that is a conveying device conveys a magnetic tape cartridge 100 between the cell 11 and a drive 14. For example, the robot 13 grasps the magnetic tape cartridge 100 with hands 102 to take it out of the cell 11, and conveys the magnetic tape cartridge 100 to the drive 14. The drive 14 accesses data stored in the magnetic tape cartridge 100. To a predetermined cell 11, a mark called a relative flag 200 is affixed. A barcode reader 101 included in the robot 13 reads the relative flag 200, thereby measuring a relative distance (relative value) between a reference position of the robot 13 and the cell 11. Note that a cartridge access station (CAS) 20 is a slot of the magnetic tape cartridges 100 into the magnetic tape library apparatus.

As operations specific to this embodiment, the controller 12 decides a target position, to which the robot 13 is to be moved, based on a position of a gravity point of the magnetic tape library apparatus, and stable position information that is predetermined position information of the gravity point at which the magnetic tape library apparatus becomes stable. Moreover, the controller 12 moves the robot 13 to the target position if a vibration applied to the magnetic tape library apparatus is detected.

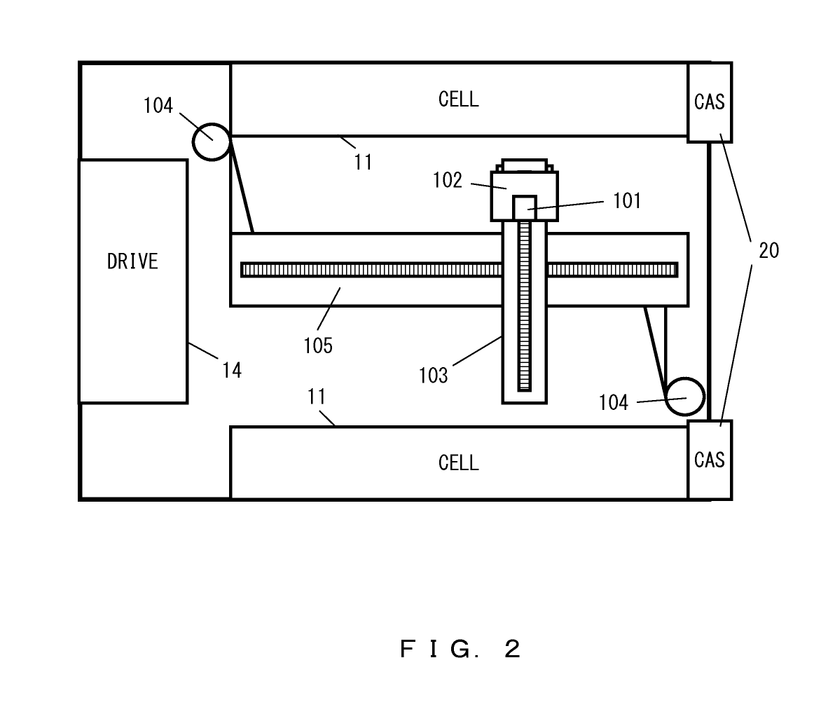

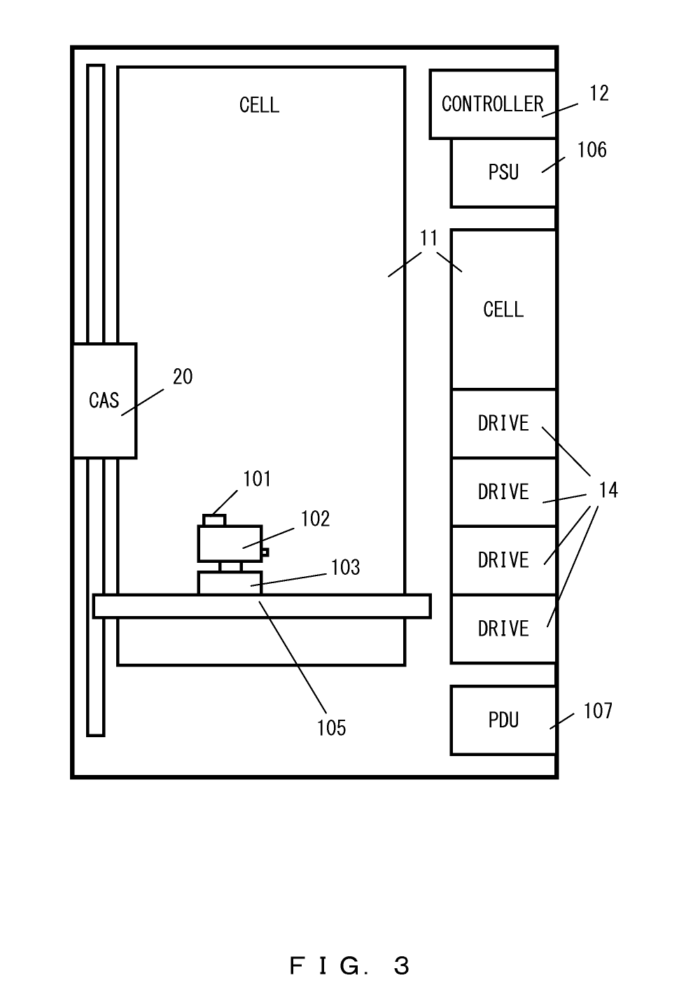

FIG. 2 illustrates an example of a top view of the magnetic tape library apparatus according to the embodiment. FIG. 3 illustrates an example of a side view of the magnetic tape library apparatus according to the embodiment. An X base 103, a Y rail 104 and a Z base 105, which are illustrated in FIGS. 2 and 3, are conveying means for conveying the hands 102 possessed by the robot 13 (see FIG. 1). The X base 103 is a base for moving the hands 102 in a width direction of the magnetic tape library apparatus. The Y rail 104 is a rail for moving the hands 102 in a height direction of the magnetic tape library apparatus. The Z base 105 is a base for moving the hands 102 in a depth direction of the magnetic tape library apparatus. The hands 102 are provided to be rotatable about a predetermined rotational axis (S axis). The controller 12 described with reference to FIG. 1 can move the hands 102 to an arbitrary position by using the X base 103, the Z base 105, the Y rail 104 or the S axis. In FIG. 3, PSU (Power Supply Unit) 106 is a power supply, whereas PDU (Power Distribution Unit) 107 is a distributor.

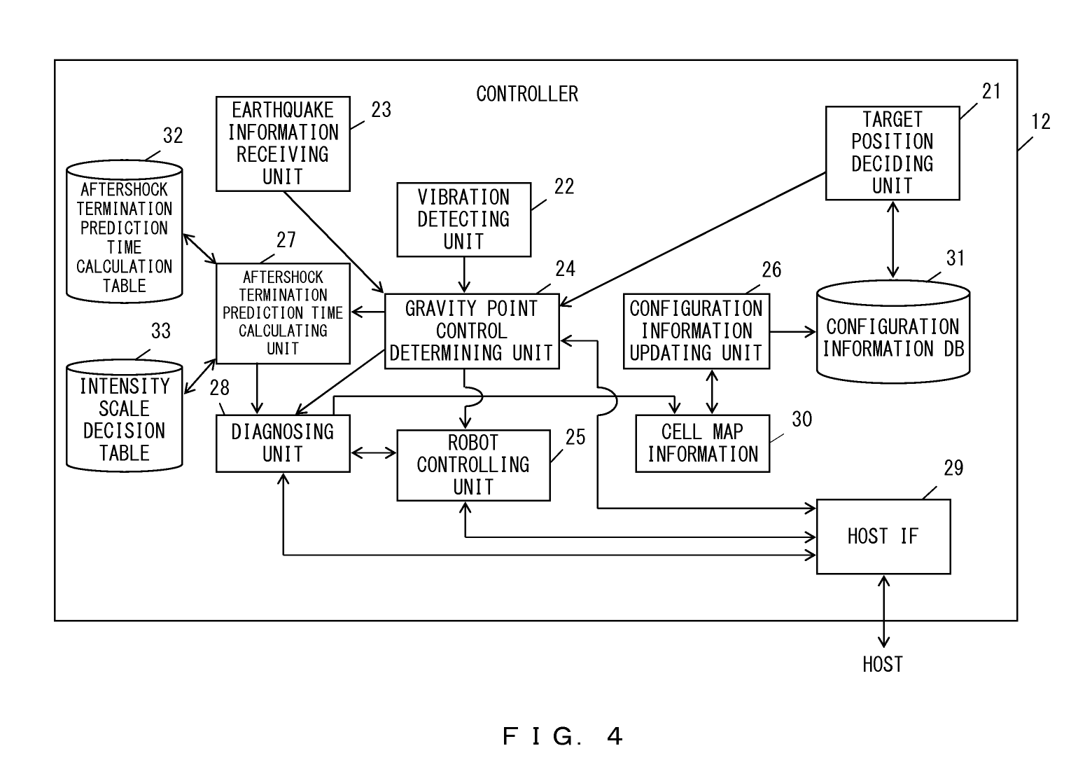

FIG. 4 illustrates a configuration example of the controller included in the magnetic tape library apparatus according to the embodiment. The controller 12 includes a target position deciding unit 21, a vibration detecting unit 22, an earthquake information receiving unit 23, a gravity point control determining unit 24, a robot controlling unit 25, a configuration information updating unit 26, an aftershock termination prediction time calculating unit 27, a diagnosing unit 28, a host interface (IF) 29, cell map information 30, a configuration information DB 31, an aftershock termination prediction time calculation table 32, and an intensity scale decision table 33.

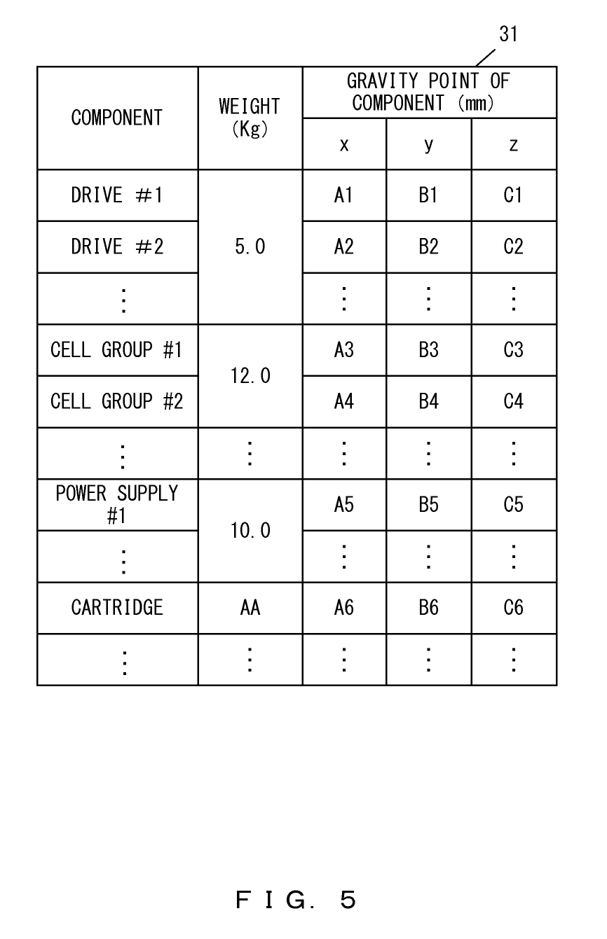

The target position deciding unit 21 decides a target position, to which the robot 13 is to be moved, based on the position of the gravity point of the magnetic tape library apparatus, and stable position information that is predetermined position information of the gravity point at which the magnetic tape library apparatus becomes stable. Specifically, the target position deciding unit 21 calculates the position of the gravity point of the magnetic tape library apparatus based on configuration information of the magnetic tape library apparatus, which is stored in the configuration information DB 31, and decides the target position based on the calculated gravity point and the stable position information. For example, the target position deciding unit 21 calculates the position of the gravity point of the entire magnetic tape library apparatus based on weights and gravity point positions, which are included in the configuration information to be described later in FIG. 5 of the magnetic tape library apparatus, of the components included in the magnetic tape library apparatus. As a result, the position of the gravity point of the magnetic tape library apparatus can be calculated with high precision. Note that the target position deciding unit 21 may decide the target position based on a predetermined position of the gravity point and stable position information of the magnetic tape library apparatus.

In this embodiment, the stable position information includes information of an area of the gravity point at which the magnetic tape library apparatus becomes stable. Then, the target position deciding unit 21 determines whether or not the calculated position of the gravity point of the magnetic tape library apparatus belongs to the area of the gravity point included in the stable position information. If determining that the position of the gravity point of the magnetic tape library apparatus does not belong to the area of the gravity point, which is included in the stable position information, the target position deciding unit 21 decides the position of the robot 13 as the target position so that the position of the gravity point of the magnetic tape library apparatus belongs to the area of the gravity point included in the stable position information. Specifically, the target position deciding unit 21 decides a driving amount of the X base, the Y rail, the Z base, or the S axis of the robot 13, which is needed so that the position of the gravity point of the magnetic tape library apparatus belong to the area of the gravity point included in the stable position information. In this way, the position of the robot 13, which is needed to stabilize the magnetic tape library apparatus, can be decided with high precision. If the target position deciding unit 21 determines that the position of the gravity point of the magnetic tape library apparatus belongs to the area of the gravity point included in the stable position information, for example, the current position of the robot is decided as the target position.

The vibration detecting unit 22 is, for example, an acceleration sensor. The vibration detecting unit 22 detects an external vibration applied to the magnetic tape library apparatus, and outputs a detection result (a magnitude of the vibration) to the gravity point control determining unit 24. The earthquake information receiving unit 23 receives earthquake information, which is information about an occurred earthquake, such as an earthquake early warning or the like.

The gravity point control determining unit 24 drives and controls the robot 13 to move to the target position if a vibration applied to the magnetic tape library apparatus is detected. For example, the gravity point control determining unit 24 determines whether or not an earthquake has occurred based on the magnitude of the vibration detected by the vibration detecting unit 22. If determining that the earthquake has occurred, the gravity point control determining unit 24 instructs the robot controlling unit 25 to move the robot 13 to the target position. More specifically, the gravity point control determining unit 24 drives the X base, the Y rail, the Z base, or the S axis of the robot 13 by the amount of driving decided by the target position deciding unit 21. The gravity point control determining unit 24 determines that the earthquake has occurred if the magnitude of the vibration detected by the vibration detecting unit 22 is larger than a predetermined magnitude of the vibration. The gravity point control determining unit 24 notifies, via the host IF 29, the host of Busy that is a signal for notifying the host to wait for a request. Moreover, the gravity point control determining unit 24 determines whether or not the vibration has terminated (the earthquake has terminated), for example, based on the magnitude of the vibration detected by the vibration detecting unit 22. Note that the gravity point control determining unit 24 may move the robot 13 to the target position at timing when the earthquake information receiving unit 23 has received the earthquake early warning.

Additionally, the gravity point control determining unit 24 instructs the robot controlling unit 25 to drive and control the robot 13 (see FIG. 1) in response to a request, for example, issued from the host, so that a magnetic tape cartridge 100 stored in the cell 11 is conveyed.

The robot controlling unit 25 drives and controls the robot 13 in accordance with an instruction of the gravity point control determining unit 24 or the diagnosing unit 28. The configuration information updating unit 26 updates the position of the gravity point of the magnetic tape cartridges 100 based on the cell map information 30, and updates the configuration information DB 31 by setting the updated position of the gravity point in the configuration information DB 31. The aftershock termination prediction time calculating unit 27 calculates an aftershock termination prediction time, which is a prediction time needed from the termination of a main quake until the termination of an aftershock. Specifically, the aftershock termination prediction time calculating unit 27 calculates a time T elapsed from the reception of the earthquake early warning until the determination that the earthquake (main quake) has occurred (until detection of a vibration by the vibration detecting unit 22), and calculates a distance to the epicenter of the main earthquake based on the calculated time T, and a predetermined seismic velocity. Moreover, the aftershock termination prediction time calculating unit 27 calculates a measurement intensity based on the magnitude of the vibration of the main quake, which is detected by the vibration detecting unit 22, and decides an intensity scale of the main quake by referencing the intensity scale decision table 33. Then, the aftershock termination prediction time calculating unit 27 calculates an aftershock termination prediction time corresponding to the above described distance to the epicenter and the decided intensity scale by using the aftershock termination prediction time calculation table 32 based on the distance and the intensity scale.

The diagnosing unit 28 diagnoses an operation of the magnetic tape library apparatus. For example, the diagnosing unit 28 self-diagnoses the controller 12 by executing a self-diagnosis program of the controller 12, which is included in the host, via a communication with the host to determine whether or not an error has occurred in the controller 12. Moreover, the diagnosing unit 28 executes an initialization process by instructing the robot controlling unit 25 to drive and control the robot 13. The initialization process is a process for determining whether or not a movable range of the robot 13 is equal to or larger than a predetermined range. Additionally, the diagnosing unit 28 measures a relative value (executes the relative value measurement process) by instructing the robot controlling unit 25 to cause the barcode reader 101 of the robot 13 to read a relative flag 200 of the cell 11. Furthermore, the diagnosing unit 28 executes an inventory process by instructing the robot controlling unit 25 to cause the barcode reader 101 of the robot 13 to read the relative flag 200 of the cell 11. The inventory process is a process for determining whether or not the barcode reader 101 has been able to read a barcode label of the magnetic tape cartridge 100. The diagnosing unit 28 decides which magnetic tape cartridge 100 is stored at which cell 11 position based on the inventory process, and updates the cell map information 30 by reflecting a decision result on the cell map information 30.

The host IF 29 mediates a communication between the gravity point control determining unit 24 and the host, a communication between the diagnosing unit 28 and the host, and a communication between the robot controlling unit 25 and the host. The cell map information 30 is information indicating which magnetic tape cartridge 100 is stored at which cell 11 position. In the configuration information DB 31, configuration information of the magnetic tape library apparatus is stored (set). The aftershock termination prediction time calculation table 32 is a table used to calculate an aftershock termination prediction time. The intensity scale decision table 33 is a table used to decide the intensity scale of a main quake.

FIG. 5 illustrates an example of the configuration information of the magnetic tape library apparatus within the configuration information DB. The configuration information of the magnetic tape library apparatus has a data structure composed of a component, a weight (Kg), and a gravity point position (mm) of the component. The component indicates a component included in the magnetic tape library apparatus. As components, for example, a drive, a cell group (a group of cells), a power supply, a cartridge (a magnetic tape cartridge in this embodiment) and the like are preset. The weight is a weight of each of the components. The gravity point position (mm) of the component is the position of a gravity point of each of the components. In the example illustrated in FIG. 5, the position of the gravity point (mm) of each of the components is represented with an x coordinate, a y coordinate, and a z coordinate with respect to a predetermined position of the magnetic tape library. The gravity point position of the drive, the gravity point position of the cell group, and the gravity point position of the power supply are fixed positions and preset in the configuration information DB 31. In the example illustrated in FIG. 5, the gravity point position of the magnetic tape cartridges, which is set in the configuration information DB 31, is the position of the gravity point of all the magnetic tape cartridges 100 stored in the cell 11. Here, the storage positions of the magnetic tape cartridges 100 in the cell 11 vary depending on a state of conveying the magnetic tape cartridge 100 by the robot 13, and accordingly, the position of the gravity point of all the magnetic tape cartridges varies. Therefore, the position of the gravity point of the magnetic tape cartridges is updated by the configuration information updating unit 26 based on the cell map information updated with the inventory process by the diagnosing unit 28, and the updated position of the gravity point is set in the configuration information DB 31.

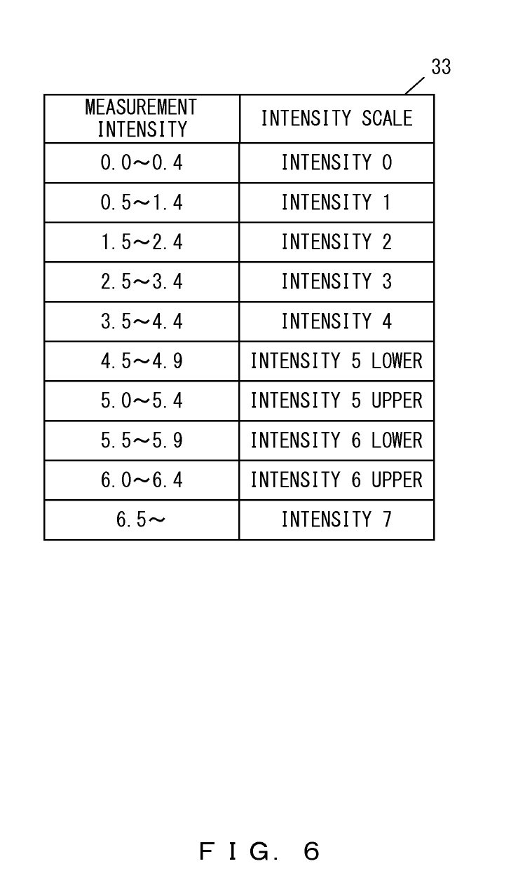

FIG. 6 illustrates an example of the intensity scale decision table. In the intensity scale decision table, information about an association between a measurement intensity and an intensity scale is present.

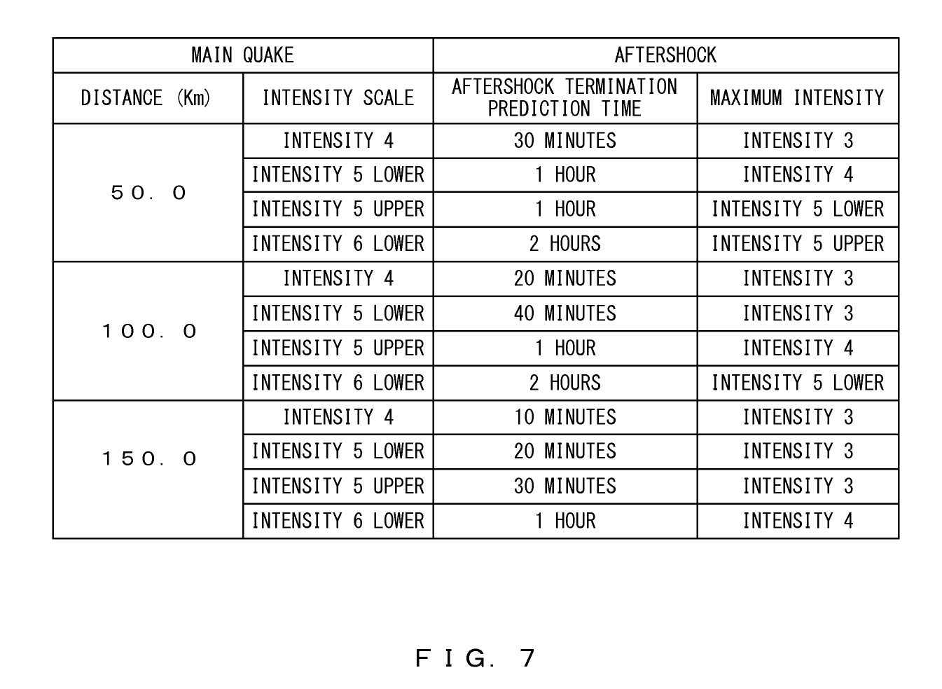

FIG. 7 illustrates an example of the aftershock termination prediction time calculation table. In the aftershock termination prediction time calculation table, an aftershock termination prediction time, and a maximum intensity of an aftershock are preset by being associated with a distance (Km) to an epicenter of a main quake, and an intensity scale of the main quake.

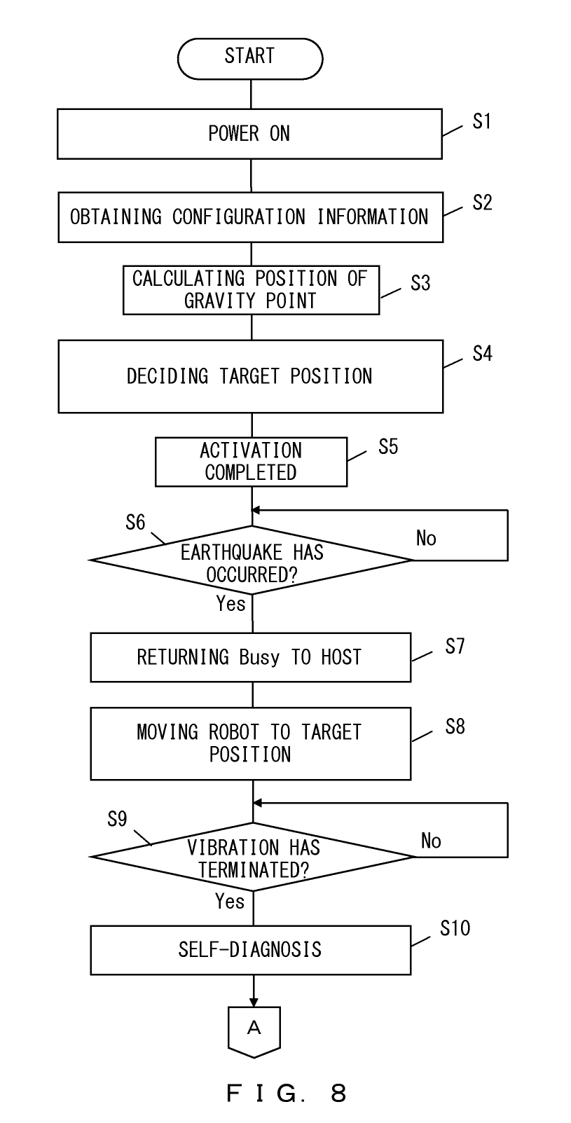

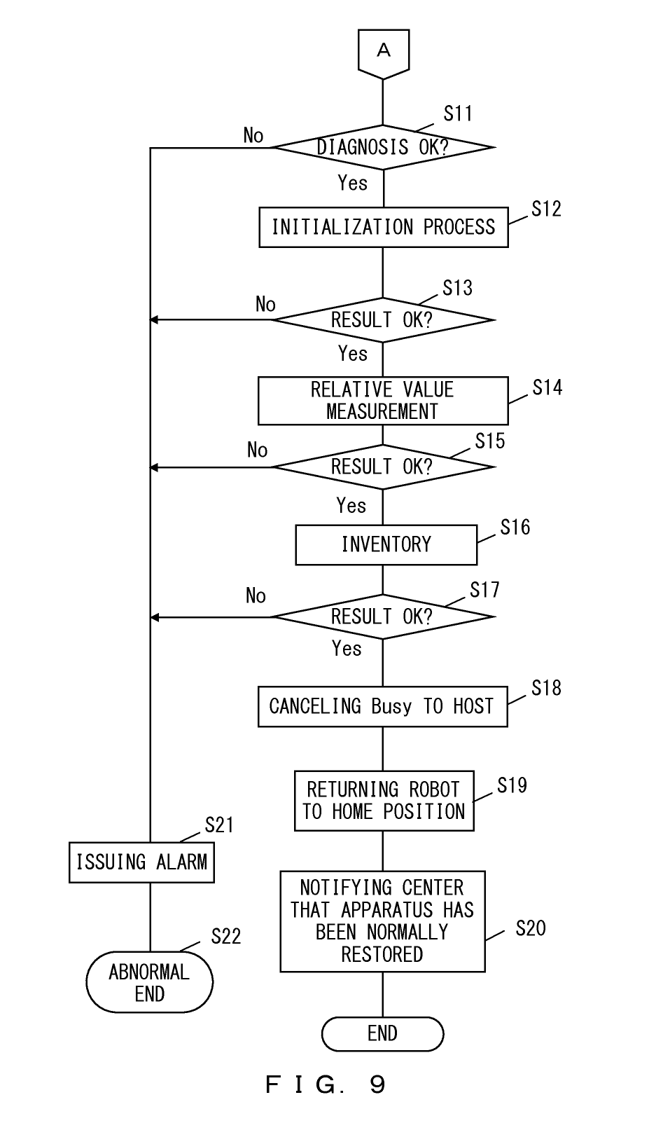

FIGS. 8 and 9 illustrate an example of a control process flow of the magnetic tape library apparatus in this embodiment. When the magnetic tape library apparatus is powered on (ON) (step S1 of FIG. 8), the target position deciding unit 21 obtains the configuration information of the magnetic tape library apparatus from the configuration information DB 31 (step S2). The target position deciding unit 21 calculates the position of the gravity point of the magnetic tape library apparatus based on the obtained configuration information of the magnetic tape library apparatus (step S3). Then, the target position deciding unit 21 decides target information, to which the robot 13 is to be moved, based on the calculated position of the gravity point and stable position information (step S4). After the process of step S4, the activation of the magnetic tape library apparatus is completed (step S5).

Next, the gravity point control determining unit 24 determines whether or not an earthquake has occurred based on a detection result of a vibration by the vibration detecting unit 22 (step S6). If the gravity point control determining unit 24 determines that the earthquake has not occurred, the flow goes back to step S6. If determining that the earthquake has occurred, the gravity point control determining unit 24 returns Busy to the host (step S7). Then, the gravity point control determining unit 24 moves the robot 13 to the target position (step S8).

Next, the gravity point control determining unit 24 determines whether or not the vibration has terminated (the earthquake has terminated) based on the detection result of the vibration by the vibration detecting unit 22 (step S9). If the gravity point control determining unit 24 determines that the vibration has not terminated yet, the flow goes back to step S9. If the gravity point control determining unit 24 determines that the vibration has terminated, the diagnosing unit 28 self-diagnoses the controller 12 (step S10). Then, in step S11 of FIG. 9, the diagnosing unit 28 determines whether or not a result of the self-diagnosis is OK, namely, whether an error has not occurred (step S11). If the diagnosing unit 28 determines that result of the self-diagnosis is not OK, the flow goes to step S21. If the diagnosing unit 28 determines that the result of the self-diagnosis is OK, the diagnosing unit 28 starts the initialization process of the robot 13 (step S12), and determines whether or not a result of the initialization process is OK, namely, whether or not the movable range of the robot 13 is equal to or larger than a predetermined range (step S13). If the diagnosing unit 28 determines that the result of the initialization process is not OK, the flow goes to step S21. If determining that the result of the initialization process is OK, the diagnosing unit 28 executes a relative value measurement process (step S14). Then, the diagnosing unit 28 determines whether or not a result of the relative value measurement process is OK, namely, whether or not a relative distance between the robot 13 and the cell 11 is, for example, equal to or larger than a predetermined distance (step S15). If determining that the result of the relative value measurement process is not OK, the diagnosing unit 28 issues an alarm to the host (step S21). Then, the magnetic tape library apparatus abnormally ends (step S22). If determining that the result of the relative measurement process is OK, the diagnosing unit 28 executes an inventory process (step S16).

Then, the diagnosing unit 28 determines whether or not a result of the inventory process is OK, namely, whether or not the barcode reader 101 of the robot 13 has been able to read a barcode label of the magnetic tape cartridge 100 (step S17). If the diagnosing unit 28 determines that the result of the inventory process is not OK, the flow goes to step S21. If determining that the result of the inventory process is OK, the diagnosing unit 28 cancels Busy to the host (step S18). Then, the diagnosing unit 28 returns the robot 13 to the home position (step S19), and notifies a maintenance center of the magnetic tape library apparatus that the magnetic tape library apparatus has been normally restored (step S20). Here, the process is terminated.

With the control process of the magnetic tape library apparatus in this embodiment described above with reference to FIGS. 8 and 9, the magnetic tape library apparatus can be prevented from losing balance even when an external vibration is applied to the magnetic tape library apparatus.

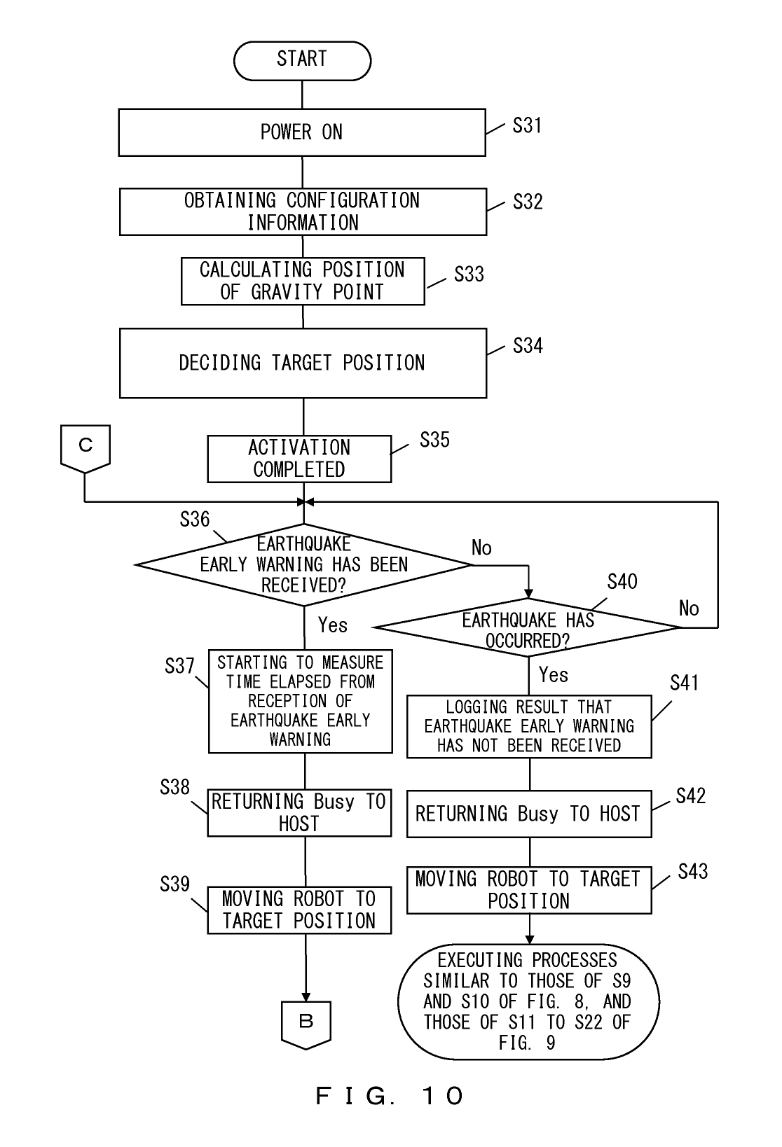

FIGS. 10 to 13 illustrate an example of a control process flow of the magnetic tape library apparatus in another embodiment. When the magnetic tape library apparatus is powered on (ON) (step S31 of FIG. 10), the target position deciding unit 21 obtains configuration information of the magnetic tape library apparatus from the configuration information DB 31 (step S32). Then, the target position deciding unit 21 calculates a position of a gravity point of the magnetic tape library apparatus based on the obtained configuration information of the magnetic tape library apparatus (step S33). Then, the target position deciding unit 21 decides a target position, to which the robot 13 is to be moved, based on the calculated position of the gravity point and stable position information (step S34). After the process of step S34, the activation of the magnetic tape library apparatus is completed (step S35).

Next, the gravity point control determining unit 24 determines whether or not the earthquake information receiving unit 23 has received an earthquake early warning (step S36). If determining that the earthquake information receiving unit 23 has not received the earthquake early warning, the gravity point control determining unit 24 determines whether or not an earthquake has occurred based on a detection result of a vibration by the vibration detecting unit 22 (step S40). If the gravity point control determining unit 24 determines that the earthquake has not occurred, the flow goes back to step S36. If determining that the earthquake has occurred, the gravity point control determining unit 24 logs, namely, stores, in a predetermined storing unit, the result of the determination that the earthquake early warning has not been received (step S41). Then, the gravity point control determining unit 24 returns Busy to the host (step S42), and moves the robot 13 to the target position (step S43). After the process of step S43, processes similar to those of the above described steps S9 and S10 of FIG. 8, and those of steps S11 to S22 of FIG. 9 are executed.

In the above described step S36, if the gravity point control determining unit 24 determines that the earthquake information receiving unit 23 has received the earthquake early warning, the aftershock termination prediction time calculating unit 27 starts to measure a time elapsed from the reception of the earthquake early warning (step S37). Then, the gravity point control determining unit 24 returns Busy to the host (step S38), and moves the robot 13 to the target position (step S39).

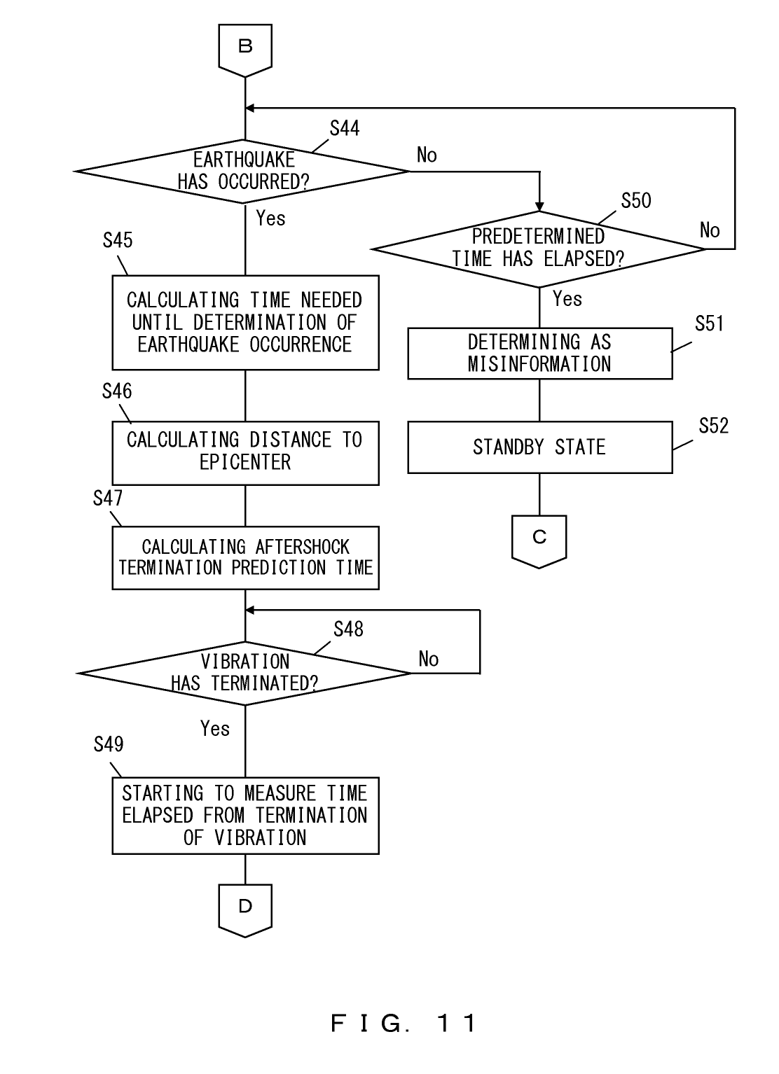

Next, in step S44 of FIG. 11, the gravity point control determining unit 24 determines whether or not an earthquake has occurred based on a detection result of a vibration by the vibration detecting unit 22 (step S44). If determining that the earthquake has not occurred, the gravity point control determining unit 24 determines whether or not a predetermined time (such as one minute) has elapsed (step S50). If the gravity point control determining unit 24 determines that the predetermined time has not elapsed, the flow goes back to step S44. If determining that the predetermined time has elapsed, the gravity point control determining unit 24 determines that the earthquake early warning is misinformation (step S51). Then, the magnetic tape library apparatus enters a standby state (step 52). The flow then goes back to step S36 of FIG. 10.

If the gravity point control determining unit 24 determines that the earthquake has occurred in the above described step S44 of FIG. 11, the aftershock termination prediction time calculating unit 27 calculates a time T needed from the reception of the earthquake early warning until the determination that the earthquake has occurred (or until the vibration detecting unit 22 has detected the vibration) (step S45). Then, the aftershock termination prediction time calculating unit 27 calculates a distance to the epicenter of a main quake based on the calculated time T, and a predetermined seismic velocity (step S46). In step S46, the aftershock termination prediction time calculating unit 27 further calculates a measurement intensity based on the magnitude of the vibration detected by the vibration detecting unit 22, and decides an intensity scale corresponding to the calculated measurement intensity by referencing the intensity scale decision table 33. The aftershock termination prediction time calculating unit 27 executes, for example, a Fourier transform process, a filter process and an inverse Fourier transform process for the magnitude of the vibration detected by the vibration detecting unit 22, and synthesizes a vector waveform from components obtained after these processes are executed. Then, the aftershock termination prediction time calculating unit 27 obtains a certain value “a” by which the total of a time during which an absolute value of the vector waveform becomes the value “a” results in, for example, 0.3 seconds. Next, the aftershock termination prediction time calculating unit 27 calculates the measurement intensity, for example, according to an equation “measurement intensity=2 log a+0.94”.

Next, the aftershock termination prediction time calculating unit 27 calculates an aftershock termination prediction time corresponding to the calculated distance in step S46 and the decided intensity scale by using the aftershock termination prediction time calculation table 32 based on the distance and the intensity scale (step S47). Then, the gravity point control determining unit 24 determines whether or not the vibration has terminated based on the detection result of the vibration by the vibration detecting unit 22 (step S48). If the gravity point control determining unit 24 determines that the vibration has not terminated yet, the flow goes back to step S48. If the gravity point control determining unit 24 determines that the vibration has terminated, the diagnosing unit 28 starts to measure a time elapsed from the termination of the vibration (step S49).

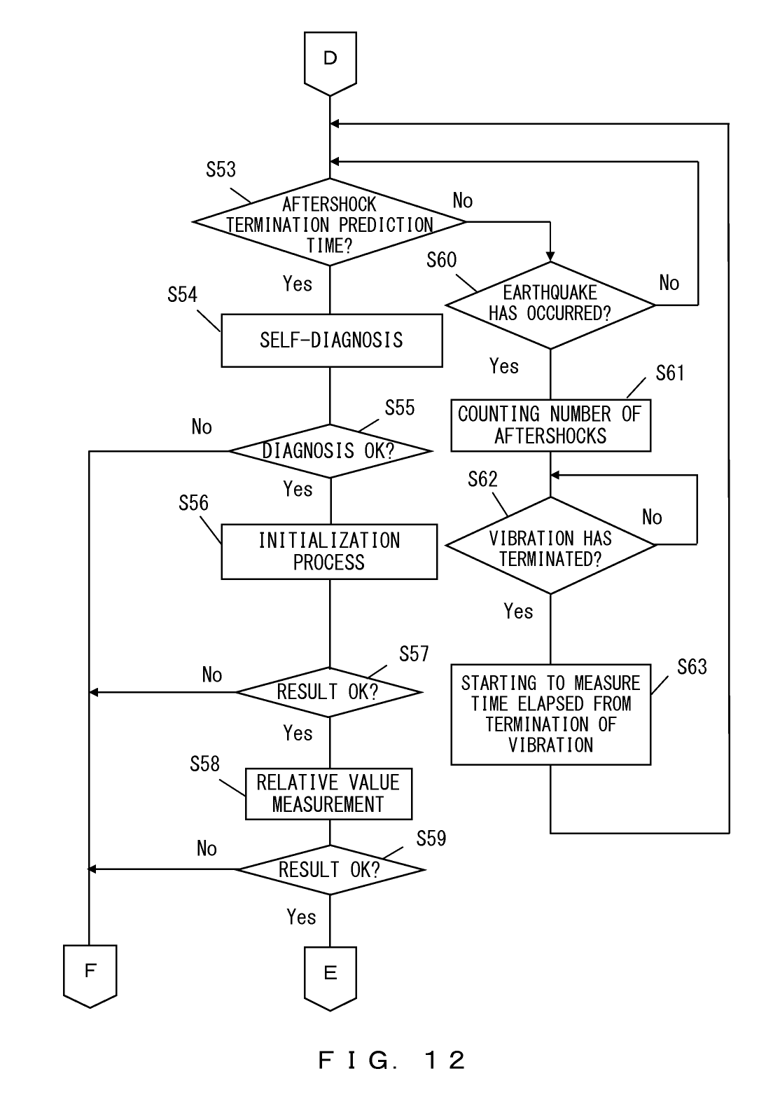

Then, in step S53 of FIG. 12, the diagnosing unit 28 determines whether or not the aftershock termination prediction time has been reached, namely, whether or not the time elapsed from the termination of the vibration exceeds the aftershock termination prediction time (step S53). If the diagnosing unit 28 determines that the aftershock termination prediction time has not been reached, the gravity point control determining unit 24 determines whether or not an earthquake (aftershock) has occurred based on the detection result of the vibration by the vibration detecting unit 22 (step S60). If the gravity point control determining unit 24 determines that the aftershock has not occurred, the flow goes back to step S53. If the gravity point control determining unit 24 determines that the aftershock has occurred, the number of aftershocks is counted and stored in a predetermined storing unit (step S61). Then, the gravity point control determining unit 24 determines whether or not the vibration has terminated based on the detection result of the vibration by the vibration detecting unit 22 (step S62). If the gravity point control determining unit 24 determines that the vibration has not terminated yet, the flow goes back to step S62. If the gravity point control determining unit 24 determines that the vibration has terminated, the diagnosing unit 28 starts to measure the time elapsed from the termination of the vibration. Then, the flow goes back to the above described step S53.

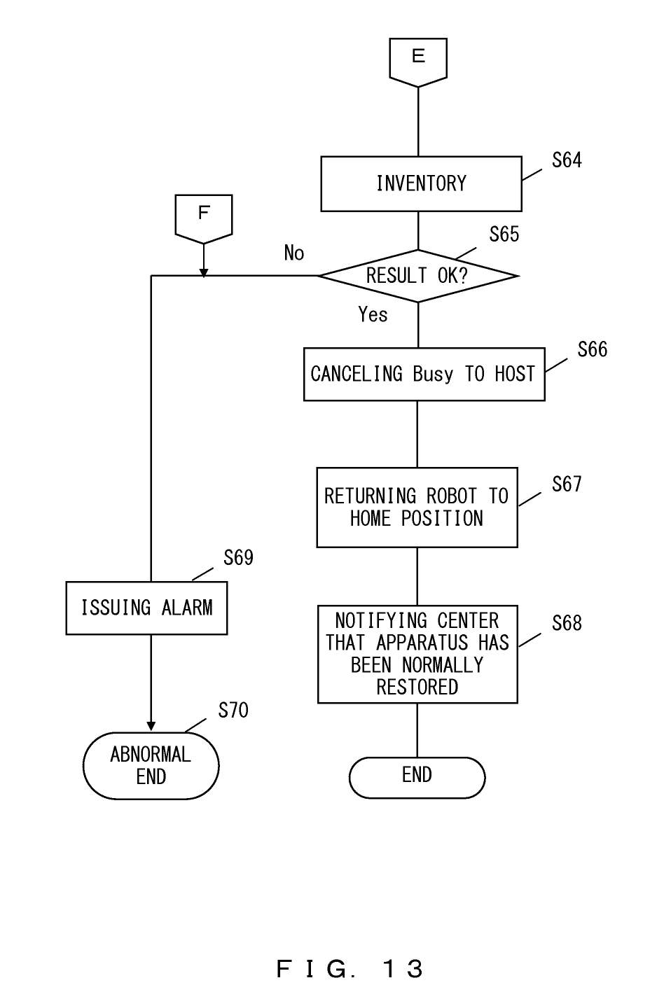

If determining that the aftershock termination prediction time has been reached in the above described step S53, the diagnosing unit 28 self-diagnoses the controller 12 (step S54), and determines whether or not a result of the self-diagnosis is OK, namely, whether an error has not occurred (step S55). If the diagnosing unit 28 determines that the result of the self-diagnosis is not OK, the flow goes to step S69 of FIG. 13. If determining that the result of the self-diagnosis is OK, the diagnosing unit 28 starts the initialization process of the robot 13 (step S56), and determines whether or not a result of the initialization process is OK, namely, whether or not the movable range of the robot 13 is equal to or larger than a predetermined range (step S57). If the diagnosing unit 28 determines that the result of the initialization process is not OK, the flow goes to step S69 of FIG. 13. If determining that the result of the initialization process is OK, the diagnosing unit 28 executes a relative value measurement process (step S58).

Then, the diagnosing unit 28 determines whether or not a result of the relative value measurement process is OK, namely, whether or not a relative distance between the robot 13 and the cell 11 is, for example, equal to or longer than a predetermined distance (step S59). If the diagnosing unit 28 determines that the result of the relative value measurement process is not OK, the flow goes to step S69 of FIG. 13. If the diagnosing unit 28 determines that the result of the relative value measurement process is OK, the flow goes to step S64 of FIG. 13, in which the diagnosing unit 28 executes an inventory process (step S64).

Then, the diagnosing unit 28 determines whether or not a result of the inventory process is OK, namely, whether or not the barcode reader 101 of the robot 13 has been able to read a barcode label of the magnetic tape cartridge 100 (step S65). If determining that the result of the inventory process is not OK, the diagnosing unit 28 issues an alarm to the host (step S69), and the magnetic tape library apparatus abnormally ends (step S70). If determining that the result of the inventory process is OK, the diagnosing unit 28 cancels Busy to the host (step S66). Then, the diagnosing unit 28 returns the robot 13 to the home position (step S67), notifies the maintenance center of the magnetic tape library apparatus that the magnetic tape library apparatus has been normally restored (step S68). Here, the process is terminated.

Note that the aftershock termination prediction time calculating unit 27 may calculate a maximum intensity of an aftershock by using the aftershock termination prediction time calculation table 32 in the above described step S47 of FIG. 11. Then, the diagnosing unit 28 may execute a predetermined process according to the calculated maximum intensity of the aftershock. For example, if the maximum intensity of the aftershock is 5 lower, the diagnosing unit 28 issues an alert to the maintenance center. Alternatively, if the maximum intensity of the aftershock is 4, the diagnosing unit 28 waits until the aftershock termination prediction time elapses. Still alternatively, if the maximum intensity of the aftershock is 3, the magnitude of the aftershock is small. Therefore, the diagnosing unit 28 immediately restores the magnetic tape library apparatus. Namely, the diagnosing unit 28 returns the robot 13 to the home position, and notifies the maintenance center that the magnetic tape library apparatus has been normally restored.

With the above described control process of the magnetic tape library apparatus with reference to FIGS. 10 to 13, the robot 13 is moved to the target position at timing when an earthquake early warning has been received. Accordingly, with this control process, the position of the gravity point of the magnetic tape library apparatus can be moved to a position at which the magnetic tape library apparatus does not lose balance before an external vibration is applied to the magnetic tape library apparatus. Moreover, with the control process of the magnetic tape library apparatus described with reference to FIGS. 10 to 13, a prediction time needed until the termination of an aftershock is calculated, and an operation of the magnetic tape library apparatus is diagnosed if the prediction time needed until the termination of the aftershock has elapsed. Accordingly, with this control process, the operation of the magnetic tape library apparatus can be diagnosed in a safe state where the aftershock has terminated.

With the library apparatus and the library apparatus controlling method according to the present invention, the library apparatus can be prevented from losing balance even if an external vibration is applied to the library apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A library apparatus for conveying, with a conveying device, a cartridge storing data between a cartridge storing unit and a drive accessing the data stored in the cartridge, the library apparatus comprising:
a target position deciding unit configured to decide a target position, to which the conveying device is to be moved, based on a position of a gravity point of the library apparatus, and stable position information that is predetermined position information of the gravity point at which the library apparatus becomes stable; and
a controlling unit configured to control and drive the conveying device to move to the target position when a vibration applied to the library apparatus is detected.

2. The library apparatus according to claim 1, wherein
the target position deciding unit calculates the position of the gravity point of the library apparatus based on configuration information of the library apparatus, which is stored in a predetermined storing unit, and decides the target position based on the calculated position of the gravity point and the stable position information, and
the controlling unit detects the vibration applied to the library apparatus, determines whether or not an earthquake has occurred based on a magnitude of the detected vibration, and drives and controls the conveying device to move to the target position if determining that the earthquake has occurred.

3. The library apparatus according to claim 2, wherein
the controlling unit receives earthquake information that is information about the occurred earthquake, and moves the conveying device to the target position at timing when the earthquake information has been received.

4. The library apparatus according to claim 3, further comprising:
an aftershock termination prediction time calculating unit configured to calculate a distance to an epicenter based on a time elapsed from reception of the earthquake information until detection of the vibration if the vibration applied to the library apparatus has been detected, and to calculate a prediction time needed until termination of an aftershock based on the calculated distance to the epicenter, and the magnitude of the detected vibration; and
a diagnosing unit configured to diagnose an operation of the library apparatus if a time elapsed from the detection of the vibration exceeds the calculated prediction time.

5. The library apparatus according to claim 2, wherein
the stable position information includes information about an area of the gravity point at which the library apparatus becomes stable, and
the target position deciding unit determines whether or not the calculated position of the gravity point of the library apparatus belongs to the area of the gravity point included in the stable position information, and to decide a position of the conveying device as the target position so that the position of the gravity point of the library apparatus belongs to the area of the gravity point included in the stable position information, if the position of the gravity point of the library apparatus is determined not to belong to the area of the gravity point included in the stable position information.

6. A controlling method for a library apparatus for conveying, with a conveying device, a cartridge storing data between a cartridge storing unit and a drive accessing the data stored in the cartridge, the controlling method comprising:
deciding a target position, to which the conveying device is to be moved, based on a position of a gravity point of the library apparatus, and stable position information that is predetermined position information of the gravity point at which the library apparatus becomes stable; and
controlling and driving the conveying device to move to the target position when a vibration applied to the library device is detected.

7. The controlling method for the library apparatus according to claim 6, wherein
the position of the gravity point of the library apparatus is calculated based on configuration information of the library apparatus, which is stored in a predetermined storing unit, and the target position is decided based on the calculated position of the gravity point, and the stable position information, and
the vibration applied to the library apparatus is detected, whether or not an earthquake has occurred is determined based on a magnitude of the detected vibration, and the conveying device is driven and controlled to move to the target position if determining that the earthquake has occurred.

8. The controlling method for the library apparatus according to claim 7, wherein
earthquake information that is information about the occurred earthquake is received, and the conveying device is moved to the target position at timing when the earthquake information has been received.

9. The controlling method for the library apparatus according to claim 8, further comprising:
calculating a distance to an epicenter based on a time elapsed from reception of the earthquake information until detection of the vibration when the vibration applied to the library apparatus is detected, and calculating a prediction time needed until termination of an aftershock based on the calculated distance to the epicenter, and the magnitude of the detected vibration; and
diagnosing an operation of the library apparatus if a time elapsed from the detection of the vibration exceeds the calculated prediction time.

10. The controlling method for the library apparatus according to claim 7, wherein
the stable position information includes information about an area of the gravity point at which the library apparatus becomes stable, and
whether or not the calculated position of the gravity point of the library apparatus belongs to the area of the gravity point included in the stable position information is determined, and a position of the conveying device is decided as the target position so that the position of the gravity point of the library apparatus belongs to the area of the gravity point included in the stable position information, if the position of the gravity point of the library apparatus is determined not to belong to the area of the gravity point included in the stable position information.

11. A library apparatus for conveying, with a conveying device, a cartridge storing data between a cartridge storing unit and a drive accessing the data stored in the cartridge, the library apparatus comprising:
a processor to:
decide a target position, to which the conveying device is to be moved, based on a position of a gravity point of the library apparatus, and stable position information that is predetermined position information of the gravity point at which the library apparatus becomes stable; and
control the conveying device to move to the target position when a vibration applied to the library device is detected.
